(19) United States
(12) Patent Application Publication
(10) Pub. No.: US 2024/0388082 A1
(43) Pub. Date: Nov. 21, 2024

(54) POWER SUPPLY SYSTEM

(71) Applicant: YAZAKI CORPORATION, Tokyo (JP)

(72) Inventors: Hayato Yamaguchi, Makinohara-shi (JP); Sadaharu Okuda, Makinohara-shi (JP)

(21) Appl. No.: 18/624,060

(22) Filed: Apr. 1, 2024

(30) Foreign Application Priority Data
May 15, 2023 (JP) 2023-079764

(51) Int. Cl. H02J 1/08; B60R 16/03

(52) U.S. Cl. CPC H02J 1/08; B60R 16/03; H02J 2310/40

(57) ABSTRACT

In a power supply system, a voltage monitor detects a voltage of output power output from a DC/DC converter. A step-down unit steps down the voltage of the output power and supplies the output power to a load. A distributor control unit controls the step-down unit based on the voltage detected by the voltage monitor. In a power satisfaction state in which the voltage detected by the voltage monitor is equal to or higher than a predetermined threshold voltage, the distributor control unit controls the step-down unit to step down the voltage of the output power and supply the output power to the load. In a power shortage state in which the voltage detected by the voltage monitor is less than the threshold voltage, the distributor control unit controls the step-down unit to supply the output power to the load without stepping down the voltage of the output power.

### CROSS-REFERENCE TO RELATED APPLICATION(S)

The present application claims priority to and incorporates by reference the entire contents of Japanese Patent Application No. 2023-079764 filed in Japan on May 15, 2023.

### BACKGROUND OF THE INVENTION

### 1. Field of the Invention

The present invention relates to a power supply system.

### 2. Description of the Related Art

Conventionally, as a power supply system, for example, Japanese Patent Application Laid-open No. 2022-057564 describes a power in-vehicle system that distributes and supplies power supplied from a power supply to a plurality of in-vehicle loads. The power in-vehicle system includes, for example, a DC/DC converter that steps down a voltage of power, a main power distribution box connected to the DC/DC converter, and an electric wiring box connected to the main power distribution box. The main power distribution box supplies the power stepped down by the DC/DC converter to the electric wiring box, and the electric wiring box supplies the power supplied from the main power distribution box to the in-vehicle load.

By the way, in the power in-vehicle system described in Japanese Patent Application Laid-open No. 2022-057564 described above, for example, it is conceivable that the voltage of the power is boosted by the DC/DC converter when the power is tight due to power consumption by the in-vehicle load. In this case, the boosted power is also supplied to the in-vehicle load with sufficient power, and thus, there is a possibility that an in-vehicle load to which the power is excessively supplied is generated.

### SUMMARY OF THE INVENTION

Therefore, the present invention has been made in view of the above, and an object thereof is to provide a power supply system capable of appropriately supplying power.

In order to achieve the above mentioned object, a power supply system according to one aspect of the present invention includes: a DC/DC converter capable of transforming a voltage of DC power; and a power distributor that distributes output power, which is the DC power output from the DC/DC converter, to a load, wherein the power distributor is configured including a voltage detection unit that detects a voltage of the output power, a step-down unit capable of stepping down the voltage of the output power and supplying the output power to the load, and a distributor control unit that controls the step-down unit based on the voltage detected by the voltage detection unit, and the distributor control unit controls the step-down unit to step down the voltage of the output power and supply the output power to the load in a power satisfaction state in which the voltage detected by the voltage detection unit is equal to or higher than a predetermined threshold voltage, and controls the step-down unit to supply the output power to the load without stepping down the voltage of the output power in a power shortage state in which the voltage detected by the voltage detection unit is less than the threshold voltage.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating a configuration example of a power supply system according to an embodiment;

FIG. 2 is a circuit diagram illustrating a configuration example of a step-down unit according to the embodiment;

FIG. 3 is a diagram illustrating an operation pattern example of the power supply system according to the embodiment; and

FIG. 4 is a flowchart illustrating an operation example of the power supply system according to the embodiment.

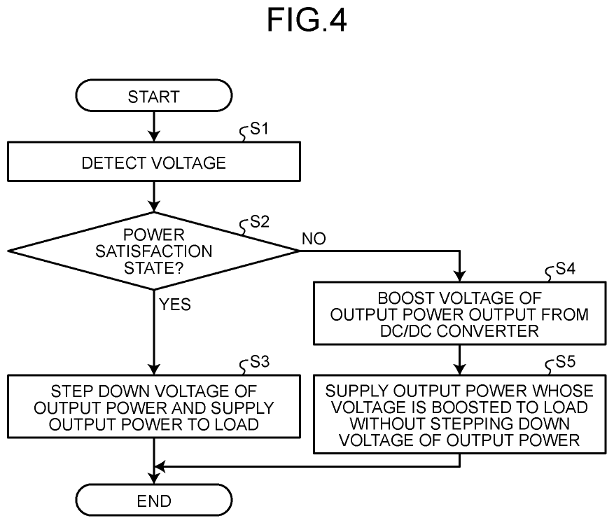

### DETAILED DESCRIPTION OF THE PREFERRED EMBODIMENTS

A mode (embodiment) for carrying out the present invention will be described in detail with reference to the drawings. The present invention is not limited by the contents described in the following embodiment. In addition, the constituent elements described below include those that can be easily assumed by those skilled in the art and those that are substantially the same. Furthermore, the configurations described below can be appropriately combined. In addition, various omissions, substitutions, or changes in the configuration can be made without departing from the gist of the present invention.

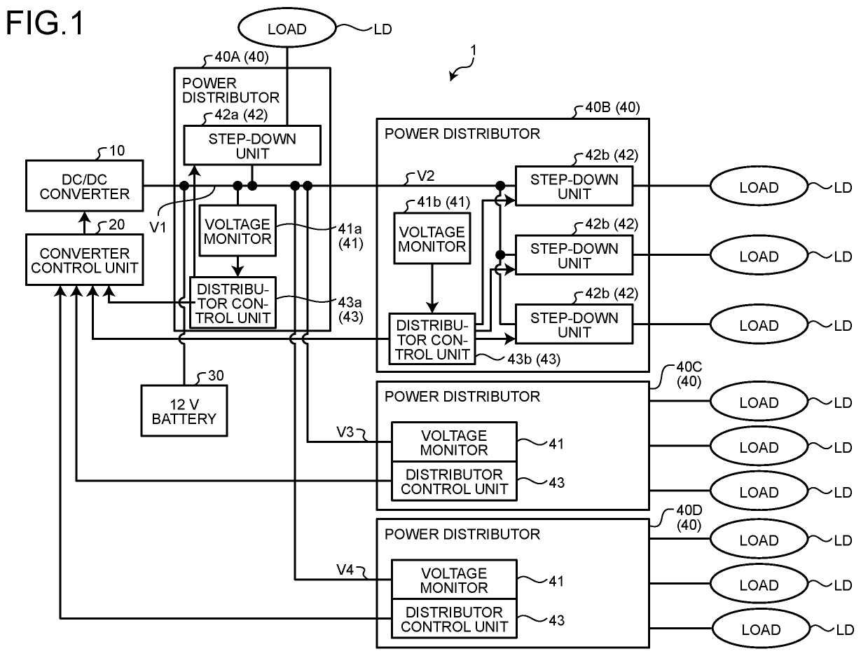

A power supply system 1 according to the embodiment will be described with reference to the drawings. The power supply system 1 is mounted on a vehicle and supplies power to loads LD of the vehicle. As illustrated in FIG. 1, the power supply system 1 includes a DC/DC converter 10, a converter control unit 20, a 12 V battery 30, and a plurality of power distributors 40 (40A to 40D). Note that in FIG. 1, the power distributors 40C and 40D have the same configuration as the power distributor 40B, and are illustrated in a simplified manner.

The DC/DC converter 10 is a converter capable of transforming a voltage of DC (direct-current) power. The DC/DC converter 10 is connected to, for example, an external power supply (not illustrated), transforms (boosts or steps down) the voltage of the DC power supplied from the power supply according to the control of the converter control unit 20, and outputs output power, which is the DC power after the transformation, to the power distributor 40A.

The converter control unit 20 controls the DC/DC converter 10. The converter control unit 20 is configured including an electronic circuit mainly including a known microcomputer including a CPU, a ROM constituting a storage unit, a RAM, and an interface. For example, when the power distributor 40 is in a power satisfaction state, the converter control unit 20 controls the DC/DC converter 10 to transform a voltage of the output power output from the DC/DC converter 10 to a voltage (normal voltage: for example, 13 V) of the output power output from the DC/DC converter 10 in the power satisfaction state. On the other hand, when the power distributor 40 is in a power shortage state, that is, when the power is tight, the converter control unit 20 controls the DC/DC converter 10 to boost the voltage of the output power output from the DC/DC converter 10 to a voltage (for example, 14 V to 15 V) equal to or higher than the voltage (13 V) of the output power output from the DC/DC converter 10 in the power satisfaction state.

The 12 V battery 30 is a power storage unit that charges and discharges power. The 12 V battery 30 is connected to the DC/DC converter 10, charges power supplied from the DC/DC converter 10, and supplies the charged power to the plurality of power distributors 40.

The plurality of power distributors 40 distribute power to the loads LD. The plurality of power distributors 40 are configured including, for example, the power distributors 40A to 40D. The power distributor 40A is connected to the DC/DC converter 10, and the power distributors 40B to 40D are connected to the power distributor 40A. That is, the plurality of power distributors 40 are configured in two levels in which the power distributor 40A is provided on an upper level side, and the power distributors 40B to 40D are provided on a lower level side of the power distributor 40A.

The power distributor 40A is configured including a voltage monitor 41a as a voltage detection unit, a step-down unit 42a, and a distributor control unit 43a. The voltage monitor 41a, the step-down unit 42a, and the distributor control unit 43a are connected so as to be able to communicate with each other.

The voltage monitor 41a detects a voltage of DC power. The voltage monitor 41a is connected to, for example, the DC/DC converter 10, and detects the voltage of output power, which is the DC power output from the DC/DC converter 10. The voltage monitor 41a outputs the detected voltage to the distributor control unit 43a.

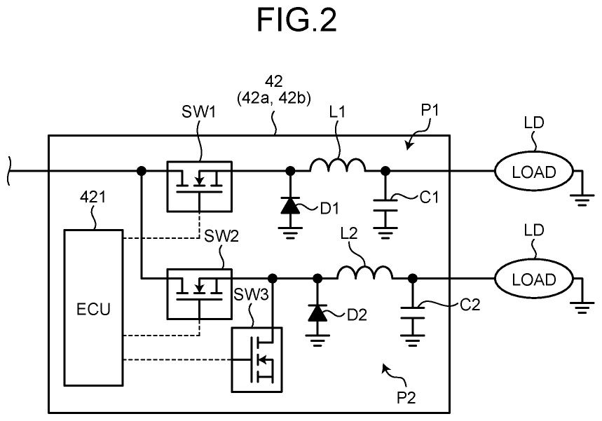

The step-down unit 42a steps down the voltage of the DC power and supplies the DC power to the load LD. The step-down unit 42a is connected to, for example, the DC/DC converter 10, steps down the voltage of the output power output from the DC/DC converter 10, and supplies the output power to the load LD. For example, the step-down unit 42a steps down the voltage (13 V) of the output power output from the DC/DC converter 10 to a predetermined voltage (for example, 11 V) and supplies the output power to the load LD. Here, as illustrated in FIG. 2, the step-down unit 42a is configured including a small-current output circuit P1, a medium-current output circuit P2, and an ECU 421.

The small-current output circuit P1 is a circuit that outputs a smaller current than the medium-current output circuit P2, and includes a switch circuit SW1, a coil L1, a diode D1, and a capacitor C1. The switch circuit SW1 has one end connected to the DC/DC converter 10 and the other end connected to the load LD. The coil L1 is provided on a power line between the switch circuit SW1 and the load LD. The diode D1 has a cathode terminal connected to the power line between the switch circuit SW1 and the coil L1, and an anode terminal connected to the ground. The capacitor C1 has one end connected to the power line between the coil L1 and the load LD, and the other end connected to the ground. The small-current output circuit P1 is used when a small current flows, and steps down the voltage of the output power output from the DC/DC converter 10 by performing PWM control on the switch circuit SW1 with the ECU 421.

The medium-current output circuit P2 is a circuit that outputs a larger current than the small-current output circuit P1, and includes switch circuits SW2 and SW3, a diode D2, a coil L2, and a capacitor C2. The switch circuit SW2 has one end connected to the DC/DC converter 10 and the other end connected to the load LD. The switch circuit SW3 has one end connected to a power line between the switch circuit SW2 and the load LD, and the other end connected to the ground. The coil L2 is provided on the power line between the switch circuit SW2 and the load LD. The diode D2 has a cathode terminal connected to the power line between the switch circuits SW2 and SW3 and the coil L2, and an anode terminal connected to the ground. The capacitor C2 has one end connected to the power line between the coil L2 and the load LD, and the other end connected to the ground. The medium-current output circuit P2 is used when a medium current flows, and steps down the voltage of the output power output from the DC/DC converter 10 by performing PWM control on the switch circuits SW2 and SW3 with the ECU 421.

The distributor control unit 43a illustrated in FIG. 1 controls the step-down unit 42a based on the voltage detected by the voltage monitor 41a. The distributor control unit 43a is configured including an electronic circuit mainly including a known microcomputer including a CPU, a ROM constituting a storage unit, a RAM, and an interface. In the power satisfaction state in which the voltage detected by the voltage monitor 41a is equal to or higher than a predetermined threshold voltage, the distributor control unit 43a controls the step-down unit 42a to step down the voltage (for example, 13 V) of the output power output from the DC/DC converter 10 to the predetermined voltage (for example, 11 V) and supply the output power to the load LD. On the other hand, in the power shortage state in which the voltage detected by the voltage monitor 41a is less than the threshold voltage, the distributor control unit 43a controls the step-down unit 42a to supply the output power output from the DC/DC converter 10 to the load LD without stepping down the voltage (for example, 14 V to 15 V) of the output power.

Next, the power distributor 40B provided on the lower level side of the power distributor 40A described above will be described. The power distributor 40B is configured including a voltage monitor 41b as a voltage detection unit, a plurality of step-down units 42b, and a distributor control unit 43b. The voltage monitor 41b, the step-down unit 42b, and the distributor control unit 43b are connected so as to be able to communicate with each other.

The voltage monitor 41b detects a voltage of DC power. For example, the voltage monitor 41b is connected to the power distributor 40A, and detects a voltage of output power output from the power distributor 40A. The voltage monitor 41b outputs the detected voltage to the distributor control unit 43b.

The step-down unit 42b steps down the voltage of the DC power and supplies the DC power to the load LD. For example, the step-down unit 42b is connected to the power distributor 40A, steps down the voltage of the output power output from the power distributor 40A, and supplies the output power to the load LD. For example, the step-down unit 42b steps down the voltage (for example, 13 V) of the output power output from the power distributor 40A to the predetermined voltage (for example, 11 V), and supplies the output power to the load LD. Note that for example, as illustrated in FIG. 2, the step-down unit 42b is configured including a small-current output circuit P1, a medium-current output circuit P2, and an ECU 421.

The distributor control unit 43b controls the step-down unit 42b based on the voltage detected by the voltage monitor 41b. The distributor control unit 43b is configured including an electronic circuit mainly including a known microcomputer including a CPU, a ROM constituting a storage unit, a RAM, and an interface. In the power satisfaction state in which the voltage detected by the voltage monitor 41b is equal to or higher than the predetermined threshold voltage, the distributor control unit 43b controls the step-down unit 42b to step down the voltage (for example, 13 V) of the output power output from the power distributor 40A to the predetermined voltage (for example, 11 V) and supply the output power to the load LD. On the other hand, in the power shortage state in which the voltage detected by the voltage monitor 41b is less than the threshold voltage, the distributor control unit 43b controls the step-down unit 42b to supply the output power output from the power distributor 40A to the load LD without stepping down the voltage (for example, 14 V to 15 V) of the output power. Note that the power distributors 40C and 40D have the same configuration as the power distributor 40B, and thus detailed description thereof will be omitted.

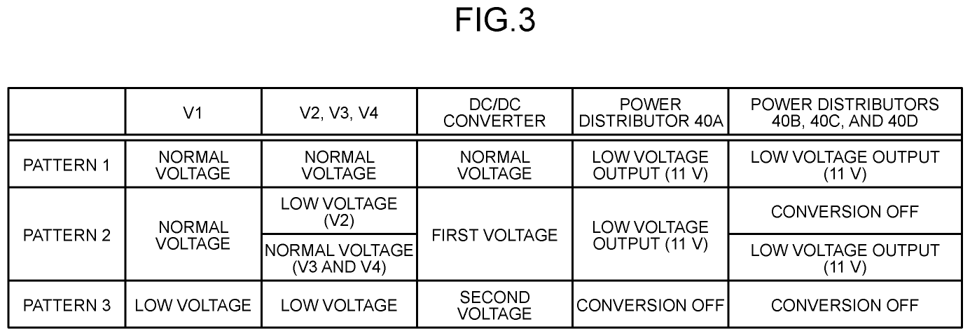

Next, an operation pattern of the power supply system 1 will be described. FIG. 3 is a diagram illustrating an operation pattern example of the power supply system 1 according to the embodiment.

As illustrated in FIGS. 1 and 3, the power supply system 1 determines that the power distributors 40A to 40D are in the power satisfaction state when voltages V1 to V4 detected respectively in the power distributors 40A to 40D are normal voltages (for example, 13 V) (pattern 1). In this case, the converter control unit 20 controls the DC/DC converter 10 to set the voltage of the output power output from the DC/DC converter 10 to the voltage (for example, 13 V) of the output power output from the DC/DC converter 10 in the power satisfaction state. The distributor control unit 43a of the power distributor 40A controls the step-down unit 42a to step down the voltage of the output power output from the DC/DC converter 10 and supply the output power to the load LD. The distributor control unit 43b of the power distributor 40B controls all the step-down units 42b to step down the voltage of the output power output from the DC/DC converter 10 and supply the output power to the loads LD. Note that similarly to the power distributors 40A and 40B, the power distributors 40C and 40D step down the voltage of the output power output from the DC/DC converter 10 and supply the output power to the loads LD.

The power supply system 1 determines that the power distributor 40B is in the power shortage state when the voltages V1, V3, and V4 detected respectively in the power distributors 40A, 40C, and 40D are equal to or higher than the threshold voltage (normal voltages) and the voltage V2 detected in the power distributor 40B is less than the threshold voltage (low voltage) (pattern 2). In this case, the converter control unit 20 controls the DC/DC converter 10 to boost the voltage of the output power output from the DC/DC converter 10 to a first voltage (for example, 14 V) that is equal to or higher than the voltage (for example, 13 V) of the output power output from the DC/DC converter 10 in the power satisfaction state. The distributor control unit 43a of the power distributor 40A controls the step-down unit 42a to step down the voltage of the output power boosted to the first voltage by the DC/DC converter 10 and supply the output power to the load LD. The distributor control unit 43b of the power distributor 40B controls all the step-down units 42b to supply the output power whose voltage is boosted to the first voltage by the DC/DC converter 10 to the loads LD without stepping down the voltage of the output power (conversion OFF). Note that similarly to the power distributor 40A, the power distributors 40C and 40D step down the voltage of the output power boosted to the first voltage by the DC/DC converter 10 and supply the output power to the loads LD.

When the voltages V1 to V4 detected respectively in the power distributors 40A to 40D are less than the threshold voltage (low voltages) (pattern 3), the power supply system 1 determines that all the power distributors 40A to 40D are in the power shortage state. In this case, the converter control unit 20 controls the DC/DC converter 10 to boost the voltage of the output power to a second voltage (for example, 15 V) that is equal to or higher than the first voltage (for example, 14 V). The distributor control unit 43a of the power distributor 40A controls the step-down unit 42a to supply the output power whose voltage is boosted to the second voltage by the DC/DC converter 10 to the load LD without stepping down the voltage of the output power (conversion OFF). The distributor control unit 43b of the power distributor 40B controls all the step-down units 42b to supply the output power whose voltage is boosted to the second voltage by the DC/DC converter 10 to the loads LD without stepping down the voltage of the output power (conversion OFF). Note that similarly to the power distributor 40B, the power distributors 40C and 40D supply the output power whose voltage is boosted to the second voltage by the DC/DC converter 10 to the loads LD without stepping down the voltage of the output power (conversion OFF).

Next, an operation example of the power supply system 1 will be described. The power distributor 40 detects the voltage of the output power output from the DC/DC converter 10 (step S1). In the power satisfaction state in which the detected voltage of the output power is equal to or higher than the threshold voltage (step S2; Yes), the power distributor 40 steps down the voltage of the output power and supplies the output power to the load LD (step S3), and the process ends. On the other hand, in the power shortage state in which the detected voltage of the output power is less than the threshold voltage (step S2; No), the power distributor 40 boosts the voltage of the output power output from the DC/DC converter 10 (step S4). Then, the power distributor 40 supplies the output power whose voltage is boosted to the load LD without stepping down the voltage of the output power (step S5), and the process ends.

As described above, the power supply system 1 according to the embodiment includes the DC/DC converter 10 and the power distributor 40. The DC/DC converter 10 is a converter capable of transforming a voltage of DC power. The power distributor 40 distributes output power, which is DC power output from the DC/DC converter 10, to the load LD. The power distributor 40 is configured including the voltage monitor 41, the step-down unit 42, and the distributor control unit 43. The voltage monitor 41 detects the voltage of the output power output from the DC/DC converter 10. The step-down unit 42 steps down the voltage of the output power and supplies the output power to the load LD. The distributor control unit 43 controls the step-down unit 42 based on the voltage detected by the voltage monitor 41. In the above configuration, in the power satisfaction state in which the voltage detected by the voltage monitor 41 is equal to or higher than the predetermined threshold voltage, the distributor control unit 43 controls the step-down unit 42 to step down the voltage of the output power and supply the output power to the load LD. On the other hand, in the power shortage state in which the voltage detected by the voltage monitor 41 is less than the threshold voltage, the distributor control unit 43 controls the step-down unit 42 to supply the output power to the load LD without stepping down the voltage of the output power.

With this configuration, since the power supply system 1 controls the voltage of the DC power to be supplied to the load LD on the power distributor 40 side, the voltage can be individually controlled for the plurality of loads LD as compared with the case where the voltage of the DC power is controlled on the DC/DC converter 10 side, and as a result, the power can be appropriately supplied to the load LD.

The power supply system 1 further includes the converter control unit 20 that controls the DC/DC converter 10. In the power shortage state, the converter control unit 20 controls the DC/DC converter 10 to boost the voltage of the output power output from the DC/DC converter 10 to a voltage equal to or higher than the voltage of the output power output from the DC/DC converter 10 in the power satisfaction state. The distributor control unit 43 controls the step-down unit 42 to supply the output power whose voltage is boosted by the DC/DC converter 10 to the load LD without stepping down the voltage of the output power. With this configuration, the power supply system 1 can appropriately supply power to the load LD by cooperatively controlling the step-down unit 42 of the power distributor 40 and the DC/DC converter 10.

In the power supply system 1, the power distributor 40 is configured including the power distributor 40A connected to the DC/DC converter 10 and the power distributor 40B connected to the power distributor 40A. The power distributor 40A is configured including the voltage monitor 41a that detects the voltage of the output power output from the DC/DC converter 10 and input to the power distributor 40A, the step-down unit 42a capable of stepping down the voltage of the output power output from the DC/DC converter 10 and input to the power distributor 40A and supplying the output power to the load LD, and the distributor control unit 43a that controls the step-down unit 42a based on the voltage detected by the voltage monitor 41a. The power distributor 40B is configured including the voltage monitor 41b that detects the voltage of the output power output from the power distributor 40A and input to the power distributor 40B, the step-down unit 42b capable of stepping down the voltage of the output power output from the power distributor 40A and input to the power distributor 40B and supplying the output power to the load LD, and the distributor control unit 43b that controls the step-down unit 42b based on the voltage detected by the voltage monitor 41b. When the power distributor 40A is in the power satisfaction state and the power distributor 40B is in the power shortage state, the converter control unit 20 controls the DC/DC converter 10 to boost the voltage of the output power to the first voltage that is equal to or higher than the voltage of the output power output from the DC/DC converter 10 in the power satisfaction state. The distributor control unit 43a controls the step-down unit 42a to step down the voltage of the output power boosted to the first voltage by the DC/DC converter 10 and supply the output power to the load LD. The distributor control unit 43b controls the step-down unit 42b to supply the output power whose voltage is boosted to the first voltage by the DC/DC converter 10 to the load LD without stepping down the voltage of the output power. Further, when the power distributor 40A and the power distributor 40B are in the power shortage state, the converter control unit 20 controls the DC/DC converter 10 to boost the voltage of the output power to the second voltage that is equal to or higher than the first voltage. The distributor control unit 43a controls the step-down unit 42a to supply the output power whose voltage is boosted to the second voltage by the DC/DC converter 10 to the load LD without stepping down the voltage of the output power. The distributor control unit 43b controls the step-down unit 42b to supply the output power whose voltage is boosted to the second voltage by the DC/DC converter 10 to the load LD without stepping down the voltage of the output power. With this configuration, by cooperatively controlling the step-down unit 42 of the power distributor 40 and the DC/DC converter 10, the power supply system 1 can individually adjust power and supply the power to the loads LD according to the respective power supply states of the power distributors 40A and 40B.

In the power supply system 1, the voltage of the output power output from the DC/DC converter 10 is set to about 13 V to 15 V, and the power distributor 40 includes the step-down unit 42 without including a boosting unit, so that the voltage of the entire system can be reduced to achieve a power saving effect.

Note that in the above description, the example in which the power supply system 1 cooperatively controls the power distributor 40 and the DC/DC converter 10 has been described, but the present invention is not limited thereto. For example, the power distributor 40 may be independently controlled to control the power to be supplied to the load LD without transforming the voltage of the output power output from the DC/DC converter 10 according to a power supply situation such as tightness.

The power supply system 1 has been described with an example in which the power distributors 40A to 40D are configured in two levels, but is not limited thereto. For example, the power supply system 1 may have a configuration of one level including only the power distributor 40A, or may have a configuration of three or more levels.

The power supply system 1 may have an integrated control unit in which the converter control unit 20 and each distributor control unit 43 are integrated, the function of the converter control unit 20 may be performed by the distributor control unit 43a of the power distributor 40A, or the function of the converter control unit 20 may be incorporated in the DC/DC converter 10 and the function of the converter control unit 20 may be performed by the DC/DC converter 10.

Since the power supply system according to the present embodiment controls the voltage of the DC power to be supplied to the load on the power distributor side, the voltage can be individually controlled for the plurality of loads as compared with the case where the voltage of the DC power is controlled on the DC/DC converter side, and as a result, the power can be appropriately supplied to the load.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A power supply system comprising:
a DC/DC converter capable of transforming a voltage of DC power; and
a power distributor that distributes output power, which is the DC power output from the DC/DC converter, to a load, wherein
the power distributor is configured including a voltage detection unit that detects a voltage of the output power,
a step-down unit capable of stepping down the voltage of the output power and supplying the output power to the load, and
a distributor control unit that controls the step-down unit based on the voltage detected by the voltage detection unit, and
the distributor control unit controls the step-down unit to step down the voltage of the output power and supply the output power to the load in a power satisfaction state in which the voltage detected by the voltage detection unit is equal to or higher than a predetermined threshold voltage, and
controls the step-down unit to supply the output power to the load without stepping down the voltage of the output power in a power shortage state in which the voltage detected by the voltage detection unit is less than the threshold voltage.

2. The power supply system according to claim 1, further comprising
a converter control unit that controls the DC/DC converter, wherein
in the power shortage state, the converter control unit controls the DC/DC converter to boost the voltage of the output power to a voltage equal to or higher than the voltage of the output power output from the DC/DC converter in the power satisfaction state, and
the distributor control unit controls the step-down unit to supply the output power whose voltage is boosted by the DC/DC converter to the load without stepping down the voltage of the output power.

3. The power supply system according to claim 2, wherein
the power distributor is configured including a first power distributor connected to the DC/DC converter and a second power distributor connected to the first power distributor,
the first power distributor is configured including a first voltage detection unit that detects a voltage of the output power output from the DC/DC converter and input to the first power distributor,
a first step-down unit capable of stepping down the voltage of the output power output from the DC/DC converter and input to the first power distributor and supplying the output power to a first load, and
a first distributor control unit that controls the first step-down unit based on the voltage detected by the first voltage detection unit,
the second power distributor is configured including a second voltage detection unit that detects a voltage of the output power output from the first power distributor and input to the second power distributor,
a second step-down unit capable of stepping down the voltage of the output power output from the first power distributor and input to the second power distributor and supplying the output power to a second load, and
a second distributor control unit that controls the second step-down unit based on the voltage detected by the second voltage detection unit,
the converter control unit controls, when the first power distributor is in the power satisfaction state and the second power distributor is in the power shortage state, the DC/DC converter to boost the voltage of the output power to a first voltage that is equal to or higher than the voltage of the output power output from the DC/DC converter in the power satisfaction state,
the first distributor control unit controls the first step-down unit to step down the voltage of the output power boosted to the first voltage by the DC/DC converter and supply the output power to the first load,
the second distributor control unit controls the second step-down unit to supply the output power whose voltage is boosted to the first voltage by the DC/DC converter to the second load without stepping down the voltage of the output power,
the converter control unit further controls, when the first power distributor and the second power distributor are in the power shortage state, the DC/DC converter to boost the voltage of the output power to a second voltage that is equal to or higher than the first voltage,
the first distributor control unit controls the first step-down unit to supply the output power whose voltage is boosted to the second voltage by the DC/DC converter to the first load without stepping down the voltage of the output power, and
the second distributor control unit controls the second step-down unit to supply the output power whose voltage is boosted to the second voltage by the DC/DC converter to the second load without stepping down the voltage of the output power.
